(19) United States
(12) Patent Application Publication
(10) Pub. No.: US 2004/0181751 A1
(43) Pub. Date: Sep. 16, 2004

(54) Reference material integration with courses in learning management systems (LMS)

(76) Inventors: Lawrence P. Frumusa, Webster, NY (US); Michael Wang, Macedon, NY (US); Susan Marie Grassi, Webster, NY (US); Holly Turner, Rochester, NY (US); Qi Sun, Pittsford, NY (US); Ann Mary Davidson, Canandaigua, NY (US); Cheryl R. Jones-Richter, Victor, NY (US); Krishna Kumar, Rochester, NY (US); Scott L. Bonisteel, Brockport, NY (US); Ankoor Bodhe, Burlington, MA (US)

Correspondence Address: FAY, SHARPE, FAGAN,, MINNICH & McKEE, LLP, Seventh Floor, 1100 Superior Avenue, Cleveland, OH, 44114-2579, US

(21) Appl. No.: 10/389,646

(22) Filed: Mar. 14, 2003

(51) Int. Cl. G06F 15/00

(52) U.S. Cl. 715/513

(57) ABSTRACT

An online course preparation method and system is provided in which reference material comprising pre-read documents is associated and made available with a respective course. The system provides for real time documents and comprises a document repository for storing course information and associated pre-read documents. A first interface is included for creating, identifying, and linking the pre-read documents to an associated course in the repository. A second interface is also provided for a user registering for an associated course. An information module identifies the user to the system and verifies authorization of the user and additionally, a processing module, coupled to the repository and the second interface, communicates real time via a communication medium the associated pre-read documents of a selected course.

### BACKGROUND

The present invention relates to data communication and processing systems, and particularly to a system for joining reference material with an associated course in a learning management system environment. As used in this application, the reference material typically is contained in a digital document repository and the learning management system includes electronic or e-learning systems. The reference material is made available to a user in real time when the user registers for a course via a communication medium.

The term “internet” means the global computer information system, including a communication medium, both as it exists currently and as it may change, evolve, or develop over time and including any replacement or successor systems. The term “intranet” means a networked computer information system, including a communication medium, typically used, accessed, and maintained by a specific group and/or company. In a typical application, an intranet is arranged such that, for example, a company and its employees can communicate with each other and with information repositories within the computer information system. Furthermore, an intranet arrangement usually prevents access from outside the network.

Presently, almost all e-learning systems are limited in that they only deal with traditional training course material maintained principally in proprietary repositories. Typically, every course has a substantial amount of associated reference material, which is mostly retained in hard copies. These hard copies may or may not be translated and captured in digital document repositories. Consequently, even if the reference material is captured in digital form, it is disjointed from the course material and thus, requires a substantial effort in order to search, locate, and make available to a course recipient or registrant. Additionally, there currently involves additional effort in order to print the reference material in the time frame essential for acquiring a hard copy before an online e-learning course, or other mode of course, is to be undertaken. The online e-learning course may either be asynchronous or synchronous with the printing of the reference material.

The present invention contemplates a new and improved approach whereby a learning management system is integrated with a digital repository. The invention involves a method and system which provides for links of reference or pre-read material in a digital document repository to be attached to associated courses set up in a learning management system. With this approach, whenever a user of a learning management system or e-learning system is browsing a course catalog, appropriate links to reference material are presented for a course and are displayed, including an option for printing. The system further includes a method for registering and authorizing users for particular courses. Users of the system are enabled either to view the reference material online and/or if authorized, the user can request printing of the reference material.

### SUMMARY

In accordance with the present invention, there is disclosed a method and system for integrating e-learning systems with digital document management systems to elevate the traditional e-learning system to a so-called “knowledge management portal”. An online course preparation system for providing real time pre-read documents comprises a document repository for storing course information and associated pre-read documents. A first interface is provided for creating, identifying, and linking the pre-read documents to at least one associated course in the repository. A second interface is provided for a user registering for at least one associated course. An information module is provided for identifying the user to the system and for verifying authorization of the user. Additionally, a processing module is coupled to the repository and the second interface for communicating real time the associated pre-read documents of the selected course.

In accordance with another aspect of the present invention, a method of integrating reference material with an associated course comprises the following steps: creating recallable information in an information repository; identifying the recallable information by at least one associated course; linking the recallable information to the at least one associated course; selecting at least one associated course and providing the recallable digital information from the repository to the user via a communication medium, whereby the reference material becomes joined to the associated course.

In accordance with more limited aspects of the invention, the system further comprises a printer for printing real time the associated pre-read documents of the selected course.

Other benefits and advantages of the subject invention will become apparent to those skilled in the art upon a reading and understanding of the specification.

### BRIEF DESCRIPTION OF THE DRAWINGS

The invention may take physical form in certain parts and steps and arrangements of parts and steps, the preferred embodiments of which will be described in detail in the specification and illustrated in the accompanying drawings which form a part hereof and wherein:

FIG. 1 is a block diagram identifying the principal components of the subject invention;

FIG. 2 is a flow diagram illustrating the steps for linking reference material to an associated course;

FIG. 3 is a flow diagram illustrating the steps of registering for a course and obtaining the associated reference material; and,

FIG. 4 is an example of reference material integrated with an associated course.

### DETAILED DESCRIPTION

The subject invention is related to an e-learning system especially applicable to courses incorporated in a learning management system and accessed through an online communication medium such as an intranet. It will be appreciated that the intranet included in the present invention may be replaced by an internet system. Once an administrator or training coordinator authenticates himself/herself, the system may be accessed and recallable digital information created in a learning management system. The subject invention uniquely provides for a user to obtain associated reference material, in particular, pre-read material, in preparation for or in conjunction with a registered course.

Referring now to the drawings, wherein the showings are for purposes of illustrating preferred embodiments of the invention only and not for purposes of limiting same, the figures show a method and system for integrating and accessing reference material associated with an e-learning course.

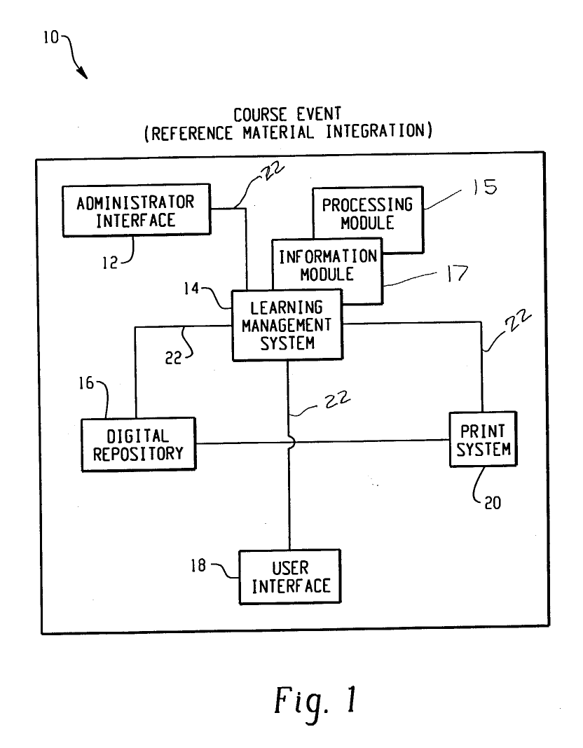

FIG. 1 is a block diagram illustrating the components of an e-learning system defining a course event 10. An administrator can access the system through an interface 12 connected, via a communication medium 22, with the learning management system 14. The learning management system 14 connects to a recallable digital repository 16 for storing and accessing documents (information). The learning management system contemplates the coordination of a processing module 15 and an information module 17. The processing module 15, according to programmed instructions, facilitates the communication of information. The information module 17 identifies users, and verifies authorization of the users, to the system 14. The repository 16 includes, but is not limited to, course catalogs, learning plans, course material, reference material associated with courses, etc. A user interface 18 is included which allows browsing of course catalogs, viewing of course material, and access to associated reference materials. The browse feature also allows the administrator a quick, casual viewing of the material contained in the learning management system 14. Easy to use menus may be employed to guide the administrator and user through the program to view course material and associated reference material, allowing a quick and easy preview of all materials or a subset of materials without opening each file. The system also includes a connection 22 to a print system 20 whereby documents may be printed.

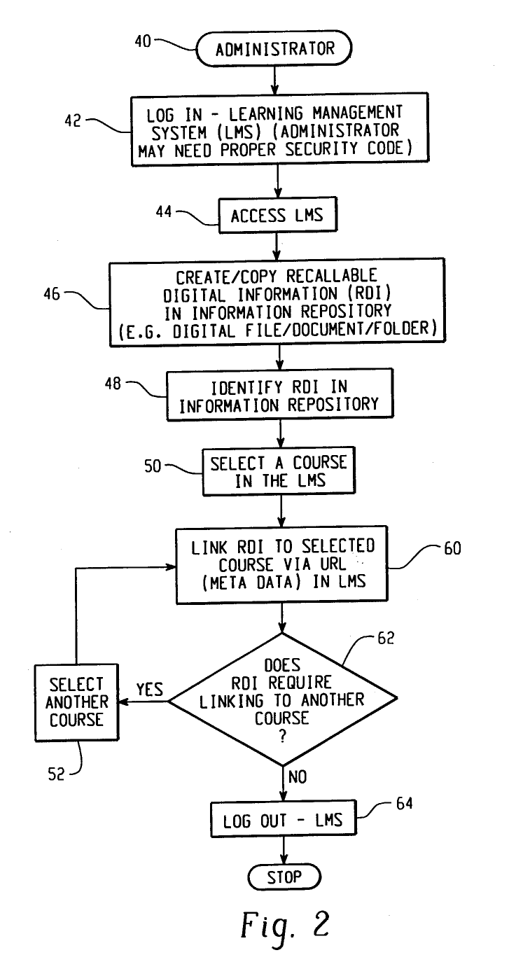

Referring now to FIG. 2, the process flow of linking reference material to a course is illustrated. An administrator 40, through an interface 42, accesses 44 the learning management system (LMS) 14. The process flow of FIG. 2 shows that the administrator 40 may need a security code to access the LMS 14. The system will query if the administrator has the proper security code (not shown) and if the answer is “yes”, then after the appropriate code is entered, the administrator can enter the system. If the initial inquiry receives an answer that the administrator does not have a security code, then the administrator must obtain and add validating information (not shown). The administrator 40 will then create or identify, for example, recallable digital information 46 within the learning management system 14. Although the recallable digital information 46 may be created by the administrator 40, it may also be acquired from another repository and attached to the associated course in the subject learning management system 14. Creating the recallable digital information 46 is facilitated by the use of a keyboard included as part of the administrator interface 42. Alternatively, a document, or series of documents, may be scanned and copied into a digital file and made available to the learning management system 14. The recallable digital information 46 is then identified 48 by assigning a URL address or meta data tag 48. This assignment of an address or tag 48 provides an identity to the recallable digital information 46 in the repository 16. Next, the administrator 40 searches and selects a course 50 from a database contained in the learning management system 14. The learning management system 14 typically is organized in a database arrangement whereby courses may be sorted and searched based upon course number, course topic, course date, etc. The administrator 40 will then attach or link 60 the recallable digital information 46 to the selected course 50. Attaching the recallable digital information 46 to a course 50 involves linking 60 the course 50 to the associated information via the URL address (meta data) in the LMS 14. The administrator 40 is also able to link 62 the recallable digital information to more than one course. This situation presents itself where the learning management system 14 includes another course(s) 52 necessarily requiring the same reference material (recallable digital information) 46. Upon completing the linking 62 of material, the administrator 40 may log-out 64 of the LMS 14.

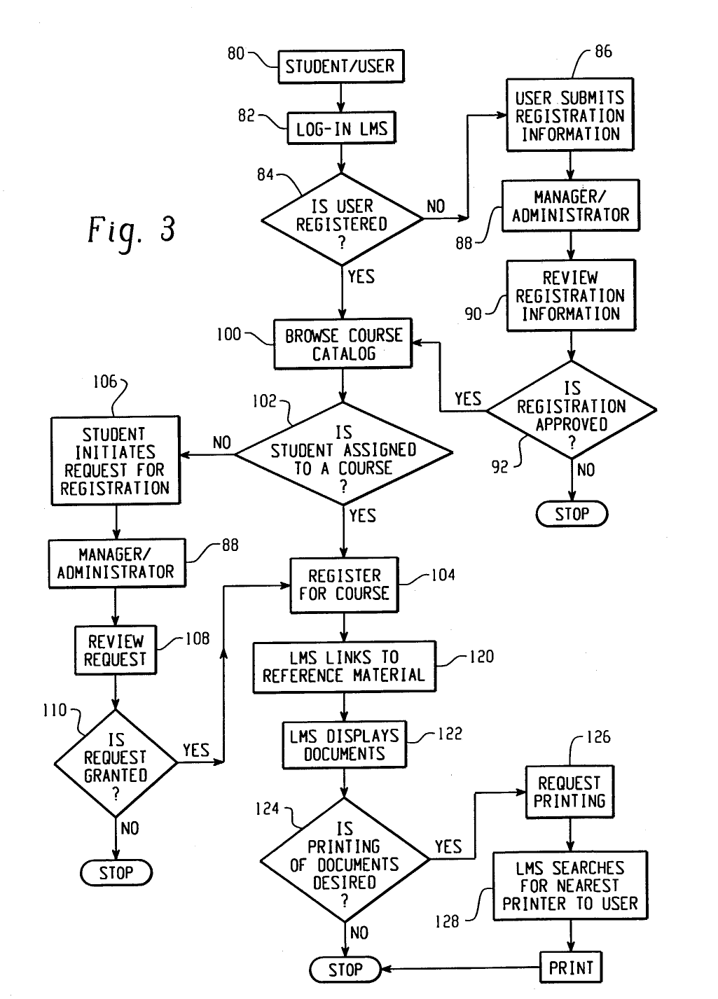

Referring now to FIG. 3, a flow diagram detailing the user interface 18 is illustrated. The student/user 80 logs into 82 the e-learning management system 14. The user 80 can only access the system 14 by being a registered user. At log-in 82, the user 80 will be asked 84 for registration information. If the user is not registered, then he/she will be allowed to submit 86 registration information. A manager or administrator 80 will review 90 the registration information and must approve 92 in order for user 80 to continue in system 14. If the student 80 is registered, then he/she continues in the system 14. Once in the system 14, the user 80 can browse 100 a course catalog. Alternatively, the user 80 may have already been assigned or queued for registration 102 to a particular course. This step 102 may have been executed by the user's manager, supervisor, or administrator. If the user 80 has been assigned to a course in the system, the user 80 will need to select and confirm registration 104 of the course.

If a user is not queued for a course, the user may initiate 106 a request for registration. Typically, the request 106 is sent to the user's manager or supervisor 88. A manager or administrator 88 will review 108 the course request 106 and must decide 110 whether or not to grant request. Once the user 80 has selected a course and followed the registration procedure 104, the learning management system 14 links 120 to the associated reference material for that particular course. The learning management system 14 connects to the repository 16 and provides to the user the appropriate reference material 46. The reference material 46 is conveyed electronically through a communication medium 22 or intranet to the user's interface 18. The user 80 can then view 122 the reference material 46 which represents pre-read information for the appropriate course. The learning management system 14 will also prompt 124 the user 80 whether a hard copy is desired. If the user 80 does not require a hard copy, the reference material will be available and viewed 122 via the user interface 18 typically comprising a graphical user interface. If the user 80 does request a hard copy, the user will then initiate printing 126 of the reference material by selecting the print command. The system has the capability of searching for the nearest printer 128 located to the user interface 18. If there is not a printer close to the user interface 18, the system will print the reference material on a central printer (not shown). In the aforementioned manner, the user 80 of the learning management system 14, upon registering for a particular course, will receive, in real time, associated pre-read and/or supplemental material in connection with the course.

As described, the aforementioned system and method contemplates the integration of the learning management system 14 and a digital repository 16. One example of the aforementioned system contemplates the integration of the DocuShare™ digital repository. DocuShare™ is a registered trademark of The Xerox Corporation, New York, dealing with computer software for document management. DocuShare™ is an intranet-based document management system. It enables approved users, regardless of location, to dynamically store, access, and share content via a communication medium and desktop applications. All content is shielded from unauthorized users through appropriate security means. DocuShare™ allows information to move from an individual to a work group or to an enterprise in an upstream or downstream manner. In other words, the information is scalable from an individual to an enterprise.

The system and approach described above adds the ability to display links to pre-read material and/or additional reference information stored in a digital repository (e.g. DocuShare™) along with the course details in the learning management system. Upon the installation of the course into the learning management system, the links to pre-read material are incorporated by adding meta data to the course, which defines the reference to the pre-read material and/or additional information in the repository. The learning management system retains these links and incorporates them into a learning plan. The user, upon entering the learning plan assigned to him/her, can either view the linked material online (via a graphical user interface), or may direct the material to a printer in order to obtain a hard copy.

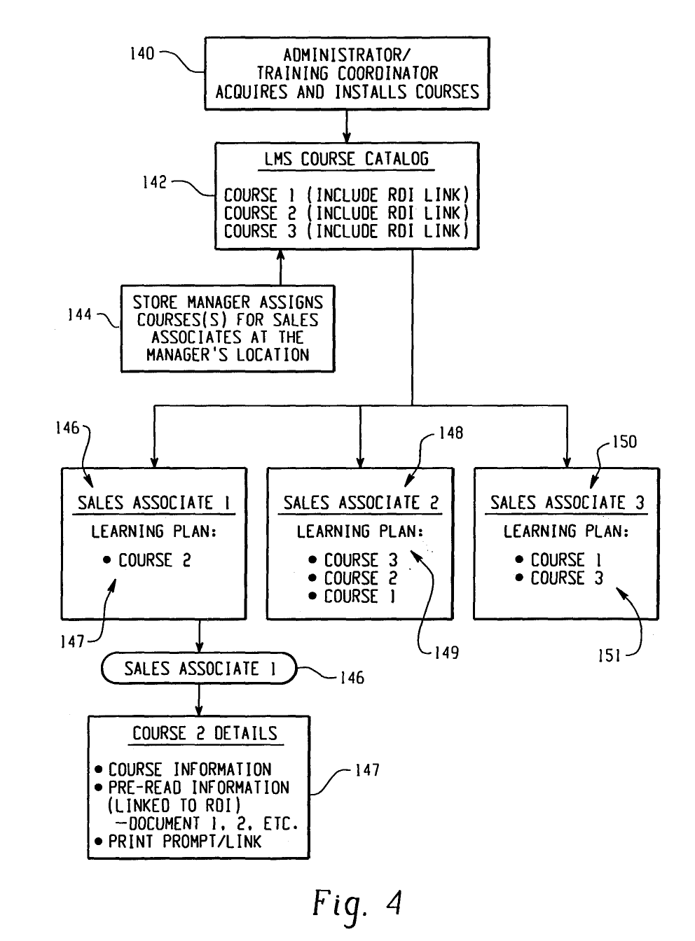

Referring now to FIG. 4, an example of a course event is illustrated. As shown, the administrator or training coordinator acquires and installs courses 140, including associated recallable digital information, which become part of a learning management system course catalog 142. In this particular example, a store manager will enter the system and select courses to be assigned 144 to each sales associate 146, 148, 150 at the manager's location. Each sales associate 146, 148, 150 will have a specific learning plan 147, 149, 151, respectively, as outlined and initiated by the store manager 144. For example, sales associate 146, upon logging into the system, will be confronted with a learning plan 147. The sales associate 146 can then access each specific course whereby the associated pre-read materials are linked. The links to the pre-read material will provide either viewing of the documents and/or the prompt to print the documents.

While particular embodiments have been described, alternatives, modifications, variations, improvements, and substantial equivalents that are or may be presently unforeseen may arise to applicants or others skilled in the art. Accordingly, the appended claims as filed, and as they may be amended, are intended to embrace all such alternatives, modifications, variations, improvements, and substantial equivalents.

Having thus described the invention, it is claimed:

1. A method of integrating reference material with at least one associated course comprising the steps of:
a) creating recallable information in an information repository;
b) identifying said recallable information by said at least one associated course;
c) linking said recallable information to said at least one associated course;
d) selecting said at least one associated course; and,
e) providing said recallable information to be conveyed from said repository to a user interface via a communication medium, whereby said reference material becomes joined to said associated course.

2. The method as defined in claim 1, further comprising the step of (f) selecting printing of said recallable information.

3. The method as defined in claim 2, further comprising the step of (g) determining the nearest printer to said user.

4. The method as defined in claim 3, further comprising the step of (h) printing said recallable information.

5. The method as defined in claim 4, wherein steps (e) thru (h) occur without said user interface.

6. The method as defined in claim 1, wherein said recallable information comprises preparatory course material.

7. The method as defined in claim 1, wherein said recallable information comprises supplemental course material.

8. The method as defined in claim 1, wherein steps (d) and (e) are concurrent.

9. The method as defined in claim 1, further comprising the step of (f) displaying said recallable information to said user interface.

10. The method as defined in claim 9, wherein said user interface comprises a graphical user interface.

11. The method as defined in claim 1, wherein said communication medium comprises an intranet.

12. The method as defined in claim 1, wherein said communication medium comprises an internet.

13. An on-line course preparation system for providing real-time pre-read documents comprising:
a document repository for storing course information and associated pre-read documents;
a first interface for creating, identifying, and linking said pre-read documents to at least one associated course in said repository;
a second interface for a user registering said at least one associated course;
an information module for identifying said user to the system and for verifying authorization of said user; and
a processing module coupled to said repository and said second interface for communicating real-time via a communication medium said associated pre-read documents of selected said at least one course.

14. The system as defined in claim 13, further comprising at least one printer;
said processing module coupled to said at least one printer for printing real-time said associated pre-read documents of selected said at least one course.

15. The system as defined in claim 14, wherein said processing module detects nearest said at least one printer to said second interface for printing real-time said associated pre-read documents.

16. The system as defined in claim 15, wherein said pre-read information comprises preparatory course material.

17. The system as defined in claim 16, wherein said pre-read information comprises supplemental course material.

18. The system as defined in claim 13, wherein said communication medium comprises an Intranet.

19. The system as defined in claim 13, wherein said processing module comprises an Internet.

20. The system as defined in claim 13, wherein said linking includes meta data attached to said at least one course.

21. An on-line training system for providing real-time learning plans and pre-read documents comprising:
a document repository for storing course information and associated pre-read documents;
a first interface for creating, identifying, and linking said pre-read documents to at least one associated course in said repository;
said at least one course defining said learning plan;
an operator of said first interface creates said learning plan for a user;
a second interface for said user identifying said user to said system and for verifying authorization of said user;
a processing module for communicating said learning plan to said user and for registering said at least one associated course;
said processing module coupled to said repository and said second interface for communicating real-time via a communication medium said associated pre-read documents of registered said at least one course.

22. The system as defined in claim 21, further comprising at least one printer; said processing module coupled to said at least one printer for printing real-time said associated pre-read documents of selected said at least one course.

23. The system as defined in claim 22, wherein said processing module detects a nearest said at least one printer to said second interface for printing real-time said associated pre-read documents.

24. The system as defined in claim 23, wherein said pre-read information comprises preparatory course material.

25. The system as defined in claim 24, wherein said pre-read information comprises supplemental course material.

26. The system as defined in claim 21, wherein said communication medium comprises an Intranet.

27. The system as defined in claim 21, wherein said communication medium comprises an Internet.

28. The system as defined in claim 21, wherein said linking includes meta data attached to said at least one course.
